(19) United States
(12) Patent Application Publication
(10) Pub. No.: US 2005/0249848 A1
(43) Pub. Date: Nov. 10, 2005

(54) Reduction of black bone defects in meat

(75) Inventors: David J. Charest, Olathe, KS (US); Eugene Brotsky, Elizabeth, NJ (US)

Correspondence Address: Scott A. McCollister, Esq.;Fay, Sharpe, Fagan, Minnich & McKee, LLP, Seventh Floor, 1100 Superior Avenue, Cleveland, OH, 44114-2518, US

(73) Assignee: Danisco A/S

(21) Appl. No.: 10/987,390

(22) Filed: Nov. 12, 2004

Related U.S. Application Data
(60) Provisional application No. 60/519,894, filed on Nov. 14, 2003.

(51) Int. Cl. A23K 1/00

(52) U.S. Cl. 426/332

(57) ABSTRACT

The invention is directed to a process to reduce blackbone occurrence in meat. The invention is further direct to reducing blackbone discoloration in meat while maintaining higher yields and without negatively affecting the appearance of the meat. The processing steps include treating the meat, preferably by injection, with an alkaline phosphate solution; and after treating the meat with the alkaline phosphate solution, contacting the meat, preferably by dipping or spraying the meat, with hexametaphosphate in an amount effective to reduce blackbone in the meat.

### FIELD OF THE INVENTION

This invention relates generally to an improved process for treating and packaging fresh meat, and more particularly, to methods for chemically treating meat and packaging/storing meat to reduce blackening of the bones in the meat. The invention also relates to maintaining the meat in an unspoiled, fresh appearing condition while reducing the occurrence of black bone discoloration in the meat over an extended period of time.

### BACKGROUND OF THE INVENTION

The treatment and packaging of fresh meat has been a subject of research and development for several years. A variety of fresh meat treatment chemicals, packaging atmospheres and packaging materials are known. Treatment chemicals have included sugar, salts, curing compounds, organic acids, isoascorbate, and the like. Packaging atmospheres generally contain varying proportions of inert gases such as carbon dioxide, nitrogen, red pigment forming gases (such as oxygen and carbon monoxide), and other gases. Many of these packaging atmospheres have been studied in conjunction with various treatment systems.

Exposure to air or oxygen over prolonged periods results in oxidation of the meat and the formation of metmyoglobin and methemoglobin, which are brown or grey in color and which detract from the appearance and sale-ability of the meat. Accordingly, many patents and articles suggest the use of polyphosphates in preserving meat and fish products to help maintain color and freshness. In red meat, for example, after the meat is processed by removing the hide and cooling, the meat, is cut into larger cuts for processing into cured or uncured (fresh meat). Cured meats are typically injected with a solution of polyphosphate, salt, and sodium nitrite, whereas fresh meat processed is typically injected with a solution of polyphosphate and salt. For example, case-ready meat is generally prepackaged in a modified atmosphere (MAP) to help maintain color and freshness, pre-weighed, and then enhanced up to about 25% with a solution of salt, alkaline phosphate, and seasonings to retain moisture.

“Case-ready meat” is a term which generally refers to meat which is prepared and packaged at a meat processing plant such that it is ready for immediate retail display and sale upon arrival at a store, where an optional barrier film layer may be removed to allow the red meat to “bloom” to a desired bright red color. An “Enhanced” case-ready meat refers to products wherein marinades or special processing “enhances” the meat. Enhanced case-ready meats are typically injected with a water, phosphate, and salt solution or marinade. The marinade generally improves flavor and sometimes yield, but can adversely affect meat appearance. For example, the alkaline phosphate generally used in the marinade to achieve higher yield and avoid storage losses can adversely affect the appearance of the meat.

Furthermore, case ready-meats are typically sold in modified atmosphere packaging, also referred to as “gas flushed” packaging, wherein various combinations of gases, such as oxygen, nitrogen and/or carbon dioxide are flushed into the package. Gas flush packaging uses oxygen in combination with carbon dioxide and/or nitrogen, which causes beef products to become the desired bright red color preferred by consumers. However the presence of a high concentration of oxygen can cause rapid bone discoloration or blackening. Blackening of the bones is often referred to as “blackbone”. Accordingly, black or discolored bones are not ideal because consumers associate bright white bones with freshness.

There exists a need in the art for an improved process for treating meat that achieves high yield and good appearance in both the meat and bones of modified atmosphere packaged case-ready meats particularly, throughout the shelf life.

### SUMMARY OF THE INVENTION

The present invention is directed to a composition and process for treating meat to maintain higher yields without negatively affecting the appearance of the meat, and in particular, to reduce black bone discoloration in modified atmosphere packaged meat. The process comprises contacting the meat, particularly the bone, preferably by dipping or spraying, with hexametaphosphate in an amount of hexametaphosphate effective for providing at least about 0.5% hexametaphosphate concentration on the surface of the bone. In a preferred embodiment the amount of hexametaphosphate concentration on the surface of the bone is from about 0.5% to about 10%. In a more preferred embodiment the amount of hexametaphosphate concentration on the surface of the bone is about 4%. The meat is then preferably stored in a modified atmosphere of greater than about 75% oxygen.

The present invention is also directed to a process to maintain higher yields without negatively affecting the appearance of the meat, and in particular, to reduce blackbone occurrence in modified atmosphere packaged meat. The process comprises the steps of 1) treating the meat, preferably by injection, with an alkaline phosphate solution; and 2) after treating the meat with the alkaline phosphate solution, contacting the meat, preferably by dipping or spraying the meat, with hexametaphosphate in an amount effective to reduce blackbone in the meat. An effective amount of hexametaphosphate for reducing blackbone is preferably at least about 0.5% hexametaphosphate concentration on the surface of the bone, and more preferably from about 0.5% to about 10% hexametaphosphate concentration on the surface of the bone, and even more preferably about 4% hexametaphosphate concentration on the surface of the bone. By treating the meat with an alkali phosphate solution then treating the bone with a hexametaphosphate solution, a high yield is achieved and blackbone occurrence is reduced.

### DETAILED DESCRIPTION OF INVENTION AND PREFERRED EMBODIMENTS

As used herein, an amount of hexametaphosphate that is “effective to reduce blackbone” means an amount of hexametaphosphate that provides improved blackbone reduction in the bones of meat, as measured by, for example, by visual evaluation or other color measurements, as compared to directly analogous bones in meat that have not been treated with hexametaphosphate.

It has been discovered, in accordance with the invention, that treating meat, particularly, the bone in the meat, by contacting the bone with hexametaphosphate (HMP) in amount of at least 0.5% HMP concentration on the bone surface, provides a reduction in the occurrence of blackbone in meat in comparison to meats that have not been treated with hexametaphosphate.

It has also been discovered, in accordance with the invention, that by treating the meat with alkaline phosphate and also treating the bone in the meat with hexametaphosphate in an amount of at least 0.5% HMP concentration on the bone surface, achieves high yield while reducing the occurrence of blackbone.

In an embodiment of the invention, the meat is treated with hexametaphosphate in amount effective to reduce the occurrence of blackening of the bones in the meat, i.e., blackbone. Particularly, the bones of the meat are contacted with a sufficient amount of HMP effective to reduce blackbone in the meat. Any suitable amounts of HMP effective to reduce blackbone in meat may be used. In a preferred embodiment, HMP is present in an amount sufficient to provide at least about 0.5% w/w HMP, more preferably from greater than about 0.5% w/w to about 10% w/w HMP, and still more preferably about 4% w/w HMP concentration on the surface of the bones of the meat. Any suitable hexametaphosphate may be used. Suitable hexametaphosphates include potassium hexametaphosphate (PHMP) and more preferably sodium hexametaphosphate (SHMP). Various chain lengths of HMP maybe used. For example, chain lengths of four (4) or more are preferred. Combinations of polyphosphates and SHMP may also be used, so long as the majority of the combination is SHMP.

The meat may be contacted with the HMP by any suitable means for allowing the HMP to contact the bones of the meat. For example, the meat may be contacted with the HMP either by tumbling, dipping, injection or spraying. Dipping or spraying of an HMP solution may be preferred in cases where it is more efficient time wise to do so. In any case, any suitable contacting mechanism by which rapid contacting is employed is more preferred. The meat should be contacted with the HMP solution for a period of time sufficient to coat the bones of the meat. For example, where the bones of the meat are exposed via cutting, the meat should be contacted in a manner such that the HMP may contact all contactable exposed surfaces of the bone. At atmospheric pressure, in a dip tank, dwell times from about 1 second to about 30 minutes are effective, with a dipping time of about 1 minute or less being preferred, and a dipping time of about at least 2 seconds being more preferred. Dwell times using a spray may range from about several seconds to about several minutes or about 2 seconds to about 15 minutes with spray times of less than 30 seconds being preferred. Dwell times using tumbling may range from about 30 seconds to several hours, with a dwell time of about less than 1 minute being preferred.

The composition of the HMP solution is preferably at least about 0.5% HMP and no more than about 99.5% water. A more preferable HMP solution comprises from about 0.5% to about 15% HMP and from about 85% to about 99.5% water. An even more preferable HMP solution may comprise about 4% HMP and about 96% water.

In another embodiment of the preset invention meat is also treated with alkaline phosphate along with the hexametaphosphate treatment in order to increase yield while maintaining the meat in an unspoiled fresh appearing condition while effectively reducing blackbone occurrence. Any suitable alkaline phosphate or combination of alkaline phosphates may be used. Suitable alkaline phosphates Include, but are not limited to, tetrasodium pyrophosphate (TSPP), tetrapotassium pyrophosphate (TKPP), sodium tripolyphosphate (STPP), or combinations thereof. The alkaline phosphate component may also include combinations of non-alkaline phosphates, for example, sodium hexametaphosphate (SHMP), sodium acid pyrophosphate (SAPP) or trisodium pyrophosphate (3SP), with one or more of the other preferred alkaline phosphates described above. For example, a suitable alkaline phosphate combination may include one of the following blends:
STPP and SHMP
STPP and SAPP
SAPP and TKPP
TSPP and TKPP

The alkaline phosphate may be in the form of an alkaline phosphate solution. The alkaline phosphate solution preferably comprises an alkaline phosphate (as described above), water, and salt. The alkaline phosphate solution is generally from about 1% to about 10% alkaline phosphate, from about 70% to about 95% water, and from about 1% to about 5% salt.

The meat may be treated or contacted with the alkaline phosphate in any suitable manner, including tumble or massage marinating or direct injection, with injection being preferred. Injection is preferred, because the injected phosphate contacts the protein more uniformly than other methods thereby resulting in improved yield and consistency. No matter which process is used, from about 3% to about 15% alkaline phosphate concentration in the solution is preferred in order to achieve from about 0.2% to about 0.7% alkaline phosphate concentration in the meat, and more preferably about 0.3% to about 0.5% alkaline phosphate concentration in the meat.

In yet another embodiment, the meat may be treated with alkaline phosphate in a two-process step. For example, a suitable two-step process may comprise the steps of 1) treating the meat, preferably by injection, with a phosphate solution having a higher pH of preferably above pH 6.0; and 2) after treating the meat with the higher pH phosphate solution, contacting the meat, preferably by dipping or spraying the meat, with a lower pH acidic solution of preferably less than about pH 5.6. The second step is believed to achieve a lower surface pH and avoid a darkening of the muscle tissue resulting from higher pH.

Suitable higher pH solutions include a higher pH phosphate, such as for example, tetrasodiumpyrophosphate (TSPP), tetrapotassium pyrophosphate (TKPP), sodium tripolyphosphate (STPP), or combinations thereof. The higher pH solution may also include a combination of alkaline and non-alkaline phosphates. Suitable non-alkaline phosphates include, for example, sodium hexametaphosphate (SHMP), sodium acid pyrophosphate (SAPP) or trisodium pyrophosphate (3SP). For example, a suitable higher pH solution may include the following blends:
STPP and SHMP
STPP and SAPP
SAPP and TKPP
TSPP and TKPP

The lower pH solution preferably comprises a lower pH phosphate. A preferred lower pH phosphate includes sodium acid pyrophosphate (SAPP). Preferred lower pH solution compositions include the following:
5% SAPP and 95% water
5% SAPP; 25% Microgard®; and 70% water
5% SAPP; 10% diacetate; and 85% water
5% SAPP; 25% Microgard®; 10% diacetate; and 60% water

For simplicity, the process will be described as the meat being treated with HMP after the meat has been treated with an alkaline phosphate. However, it should be understood, that the process may occur in any suitable order. For example, the meat may be treated with HMP first and then treated with alkaline phosphate. Accordingly, in an embodiment of the invention, after the meat is treated with alkaline phosphate, the meat is then treated with HMP. If the meat does not have any exposed surfaces of the bone, the meat may be injected to contact the bone with HMP or the meat may then be cut to expose a surface of the bone, prior to treating with HMP.

As discussed above, the bone is treated with an amount of HMP effective to reduce blackbone occurrence. Any suitable amounts of HMP effective to reduce blackbone in meat may be used. In a preferred embodiment, HMP is present in an amount sufficient to provide at least about 0.5% w/w HMP, more preferably from greater than about 0.5% w/w to about 10% w/w HMP, and still more preferably about 0.4% w/w HMP concentration on the surface of the bones of the meat.

Also as discussed above, any suitable hexametaphosphate may be used. Suitable hexametaphosphates include potassium hexametaphosphate (PHMP) and more preferably sodium hexametaphosphate (SHMP). Various chain lengths of HMP maybe used. For example, chain lengths of four or more are preferred. Combinations of polyphosphates and SHMP may also be used, so long as the highest concentration of the combination is SHMP.

The bone may be contacted with the HMP either by tumbling, dipping, spraying, or injection of the meat. Dipping or spraying of an HMP solution may be preferred in cases where it is more efficient time wise to do so. In any case, any suitable contacting mechanism by which rapid contacting is employed is more preferred. The bone should be contacted with the acidic solution for a period of time sufficient to coat the surface of the bones of the meat i.e., such that the HMP may contact all contactable exposed surfaces of the bone. At atmospheric pressure, in a dip tank, dwell times from about 1 second to about 30 minutes are effective, with a dipping time of about 1 minute or less being preferred, and a dipping time of about at least 2 seconds being more preferred. Dwell times using a spray may range from about several seconds to about several minutes or about 2 seconds to about 15 minutes with spray times of less than 30 seconds being preferred. Dwell times using tumbling may range from about 30 seconds to several hours, with a dwell time of about less than about 1 minute being preferred.

It should also be appreciated that the compositions of the solutions used in the process of the invention may be varied according to the desired characteristics of the meat. The following non-limiting examples will further illustrate the preparation and performance of the preferred compositions and processes in accordance with the invention. However, it is to be understood that these examples are given by way of illustration only and are not a limitation of the invention.

### EXAMPLE

A phosphate solution was prepared by dispersing dry pre-blended phosphate into cold water and stirring with a mixer until the phosphates were dissolved completely. The phosphate solution used in the example had a composition of 93.1% water, 3.8% NaCl, and 3.1% phosphates. Fresh beef loin and pork loin strips having similar size and weight were used. A sodium hexametaphosphate solution was prepared by mixing sodium hexametaphosphate, water, and salt. The SHMP solution used in the example had a composition of 96% brine (salt and water) and 4% SHMP.

The temperature of the beef loin and pork loin strips was maintained at about 36° F. The beef loin and pork loin strips were injected up to about 15% extension with the phosphate solution. Then the beef loin strips were cut into 1 inch steaks and the pork loin strips were cut into 1 inch chops by cutting the bones in half. The steaks and chops were allowed to drip for two minutes. Next the Control steaks and Control chops, was set aside, while the other steaks and chops were treated with the SHMP solution. The Control steaks and chops were dipped in the SHMP solution for about two (2) seconds.

The SHMP dipped steaks and chops were then drained for about one minute on a rack. All of the steaks and chops, including the Controls, were placed on trays lined with soak pads and into gas impermeable bags. The gas impermeable bags were closed using a modified atmosphere of about 80% oxygen (O₂) and about 20% carbon dioxide (CO₂). The steaks and chops were then stored at about 36° F. for up to 18 days. Visual evaluations were performed before and after treatment, as well as at various time intervals.

Visual Evaluation
Pork loin

| | |
|---|---|
| Control | SHMP |
| (No Dip) | DIP |
| A | B |

| | | |
|---|---|---|
| fresh | meat | no differences |
| | bone | spots are visible on all |
| | | bones |
| after | meat | no differences |
| treatment | bone | no spots are visible |
| 2 days | meat | no differences |
| | bone | not as red and dryer in |
| | | appearance, no spots |
| 3 days | meat | no differences |
| | bone | no spots are visible |
| 5 days | meat | no differences |
| | bone | no spots are visible |
| 7 days | meat | no differences |
| | bone | no spots are visible |
| 13 days | meat | |

| | | |
|---|---|---|
| bone | 4 w/spots | 3 w/spots |

only slight differences

| | | | |
|---|---|---|---|
| 15 days | meat | | |
| | bone | 1 w/out spots | 2 w/out spots |

*see comment below

| | | | |
|---|---|---|---|
| 16 days | meat | red | red |

no difference

| | | |
|---|---|---|
| bone | black | little to no |
| | discoloration | black |
| | | discoloration |

difference big

| | | | |
|---|---|---|---|
| 18 days | meat | red | red |

no difference

| | | |
|---|---|---|
| bone | intense | less black |
| | black | |

*Control is showing more spots as well as bigger spots than SHMP treated chop.

All of the SHMP treated chops exhibited reduced blackbone discoloration at storage times of 15 days or longer. After sixteen days the Control showed significant blackbone discoloration while the SHMP treated chops showed little to no blackbone discoloration.

1. A process for treating meat to reduce blackening of the bones comprising treating meat with an amount of hexametaphosphate effective to reduce blackening of bones in the meat.

2. The process of claim 1 wherein said step of treating the meat comprises contacting the bones of the meat with hexametaphosphate.

3. The process of claim 1 wherein said step of treating the meat comprises tumbling, dipping or spraying the meat.

4. The process of claim 1 further comprising storing said meat in a modified atmosphere of greater than about 75% oxygen, after treating said meat with hexametaphosphate.

5. The process of claim 4 wherein said reduced blackening of the bones is exhibited at storage times of at least 15 days.

6. The process of claim 1 wherein said amount of hexametaphosphate is at least about 0.5% hexametaphosphate concentration on a surface of the bones.

7. The process of claim 5 wherein said amount of hexametaphosphate is between about 0.5% to about 10% hexametaphosphate concentration on a surface of the bones.

8. The process of claim 5 wherein said amount of hexametaphosphate is about 4% hexametaphosphate concentration on a surface of the bones.

9. The process of claim 1 wherein said hexametaphosphate comprises potassium hexametaphosphate.

10. The process of claim 1 wherein said hexametaphosphate comprises sodium hexametaphosphate.

11. A process for treating meat to reduce bone discoloration comprising the steps of:
treating a bone containing meat with an alkaline phosphate;
treating a surface of said bone in said bone containing meat with hexametaphosphate; and
storing said bone containing meat in an oxygen atmosphere.

12. The process of claim 11 wherein said surface of said bone is treated with an amount hexametaphosphate effective to reduce discoloration of said bone.

13. The process of claim 12 wherein said amount of hexametaphosphate is at least about 0.5% hexametaphosphate concentration on a surface of the bones.

14. The process of claim 13 wherein said amount of hexametaphosphate is between about 0.5% to about 10% hexametaphosphate concentration on a surface of the bones.

15. The process of claim 13 wherein said amount of hexametaphosphate is about 4% hexametaphosphate concentration on a surface of the bones.

16. The process of claim 11 wherein said meat is treated with an amount of said alkaline phosphate effective to increase yield in said meat.

17. The process of claim 16 wherein said amount of said alkaline phosphate is from about 0.2% to about 0.7% alkaline phosphate concentration in the meat.

18. The process of claim 17 wherein said amount of said alkaline phosphate is from about 0.3% to about 0.5% alkaline phosphate concentration in the meat.

19. The process of claim 11 wherein treating said bone containing meat with an alkaline phosphate comprises a two step process.

20. The process of claim 19 wherein said two step process comprises treating the meat with a phosphate solution having a higher pH of above about 6.0: and after treating the meat with the higher pH solution, treating the meat an acidic solution having a lower pH of less than about 5.6.

21. The process of claim 1 1 wherein said alkaline phosphate comprises tetrasodium pyrophosphate (TSPP), tetrapotassium pyrophosphate (TKPP), sodium tripolyphosphate (STPP), or combinations thereof.

22. The process of claim 11 wherein said oxygen atmosphere is a modified atmosphere of greater than about 75% oxygen.

23. The process of claim 11 wherein said step of storing comprises gas flush packaging said meat.

24. The process of claim 11 wherein storing said meat is for at least 15 days.

25. The process of claim 11 wherein said hexametaphosphate comprises potassium.

26. The process of claim 11 wherein said hexametaphosphate comprises sodium.

27. A method for treating a meat to reduce blackbone occurrence, comprising the steps of:
providing bone-in meat;
treating said bone-in meat with a hexametaphosphate composition to produce hexametaphosphate treated bone-in meat;
storing said hexametaphosphate treated bone-in meat in a modified atmosphere of at least about 75% oxygen; and
reducing blackbone occurrence in hexametaphosphate treated meat below an amount of blackbone occurrence in a bone-in meat having no hexametaphosphates therein.

28. Bone-in meat comprising an amount of hexametaphosphate effective to reduce blackening of bones in said bone-in meat.

29. The process of claim 1 wherein said hexametaphosphate has varying chain lengths.

30. The process of chain 29 wherein said hexametaphosphate has a chain length of at least four.

31. The process of claim 11 wherein said hexametaphosphate has varying chain lengths.

32. The process of chain 31 wherein said hexametaphosphate has a chain length of at least four.

33. The process of claim 27 wherein said hexametaphosphate has varying chain lengths.

34. The process of chain 33 wherein said hexametaphosphate has a chain length of at least four.
